(19) United States
(12) Patent Application Publication
(10) Pub. No.: US 2024/0035114 A1
(43) Pub. Date: Feb. 1, 2024

(54) ZINC RECOVERY METHOD

(71) Applicant: CHUGAI RO CO., LTD., Osaka-shi, Osaka (JP)

(72) Inventors: Yoshifumi ITO, Osaka-shi, Osaka (JP); Toshiyuki OKUMURA, Osaka-shi, Osaka (JP)

(21) Appl. No.: 18/255,641

(22) PCT Filed: Sep. 9, 2021
(86) PCT No.: PCT/JP2021/033071

§ 371 Date: Jun. 2, 2023

(30) Foreign Application Priority Data
Feb. 12, 2021 (JP) 2021-020430

(51) Int. Cl. C22B 19/04; F27B 7/08; F27B 7/20; C22B 7/02

(52) U.S. Cl. CPC C22B 19/04; F27B 7/08; F27B 7/2075; C22B 7/02

(57) ABSTRACT

Dust Da containing zinc and iron is charged in a rotative cylindrical kiln base body 11 of an indirect-heating rotary kiln 10 and is subjected to heat treatment in the kiln base body so that zinc contained in the dust is volatilized. The volatilized zinc is guided to a treatment device 30 through an exhaust pipe 31 disposed at a discharge part 16 of the rotary kiln and is recovered. A residue Db resulting from the treatment in the kiln base body is transferred from a residue outlet 16b disposed at the discharge part 16 of the rotary kiln to a burner device 40, in which the residue is combusted and heated.

### TECHNICAL FIELD

The present invention relates to a zinc recovery method for recovery of zinc from dust containing zinc and iron such as electric furnace steelmaking dust. More particularly, the invention is characterized by a simple and low-cost recovery of zinc and the like from the dust containing zinc and iron such as the electric furnace steelmaking dust.

### BACKGROUND ART

It has been a conventional practice to recover zinc and the like from the dust containing zinc and iron such as the electric furnace steelmaking dust.

According to a method set forth in Patent Document 1, zinc and the like is recovered from the dust containing zinc and iron as follows. A zinc-containing dust produced at an iron mill is molten in a melting furnace to obtain molten iron. On the other hand, the dust obtained from an exit side of the melting furnace is washed with water. Subsequently, the dust is charged in a rotary kiln where the dust is reduction roasted at temperatures in a range from 907° C. to 1023° C. for volatilization of zinc. Thus, crude zinc oxide is recovered. In the meantime, the residue discharged from the rotary kiln is returned to the melting furnace for remelting.

However, the following problem still exists even in the case where the dust is subjected to the reduction roasting at temperatures in the range from 907° C. to 1023° C. for volatilization of zinc so as to recover zinc as crude zinc oxide. That is, a cylindrical base body of the kiln suffers adhesion of impurities to an inner periphery thereof. What is more, the residue contains iron oxide. In a case where the residue is returned to the melting furnace to be molten again, heat is used for reducing the iron oxide contained in the residue. This results in a decrease in thermal efficiency.

### CITATION LIST

### Patent Document

Patent Document 1: JPA 2006-241574

### DISCLOSURE OF INVENTION

### Technical Problem

An object of the invention is to solve the above-described problems encountered when zinc and the like are recovered from the dust containing zinc and iron such as the electric furnace steelmaking dust.

The present invention addresses the following problems to provide the simple and low-cost recovery of zinc and the like from the dust containing zinc and iron. Specifically, the invention is adapted to prevent the adhesion of the impurities to the inner periphery of the cylindrical kiln base body when the dust containing zinc and iron is charged in the rotative cylindrical kiln base body and heat treated for volatilizing zinc contained in the dust. The invention is further adapted to prevent the decrease in thermal efficiency due to heat loss associated with the reduction of iron oxide when the residue containing iron oxide is returned to the melting furnace to be molten again.

### Solution to Problem

According to the invention for solving the above-described problems, a zinc recovery method includes the steps of: charging dust containing zinc and iron in a rotative cylindrical kiln base body of an indirect-heating rotary kiln, and heat treating the dust in the kiln base body so as to volatilize zinc contained in the dust;
guiding the volatilized zinc to a treatment device through an exhaust pipe disposed at a discharge part of the rotary kiln and recovering zinc; and
transferring a residue resulting from the treatment in the kiln base body from a residue outlet disposed at the discharge part of the rotary kiln to a burner device in which the residue is combusted and heated.

The above-described indirect-heating rotary kiln offers the following advantages. In a case where the dust containing zinc and iron is charged in a rotative kiln base body and heat treated to volatilize zinc contained in the dust, the dust can be treated at the temperature controlled to be in the range from 950 to 1000° C. where no dioxin is produced. This leads to the simple and low-cost recovery of zinc and the like.

Examples of a rotary kiln usable for the zinc recovery method according to the invention include: a single-cylinder type rotary kiln which includes a single large-diameter kiln base body as the above-described cylindrical kiln base body; and a multi-cylinder type rotary kiln including a plurality of small-diameter kiln base bodies circumferentially arranged at given space intervals. In a case where the multi-cylinder type rotary kiln including the plural kiln base bodies circumferentially arranged at given space intervals is used, the dust can be efficiently heat treated in each of the kiln base bodies. Therefore, the rotary kiln of this type can not only be downsized by reducing the length of the rotary kiln but also can achieve further reduction of treatment costs required for treating the above-described dust.

The residue resulting from the above-described heat treatment to volatilize zinc from the dust in the kiln base body is transferred from the residue outlet disposed at the discharge part of the rotary kiln to the burner device, where the residue is combusted and heated. If this operation is performed, the residue removed of zinc but rich in iron can be readily molten in an electric furnace. This provides for not only a low-cost efficient utilization of iron contained in the residue but also the reduction of costs required for separately performed residue disposal.

According to the zinc recovery method of the invention, it is preferred to provide an adhesion inhibition means for inhibiting the adhesion of impurities onto the inside of the kiln base body when the dust containing zinc and iron is charged in and heat treated by the rotative kiln base body of the indirect-heating rotary kiln so as to volatilize zinc contained in the dust. Such an adhesion inhibition means can be exemplified by: a round member extended in an axial direction of the kiln base body and rollably disposed in the kiln base body; a scraper member extended in the axial direction of the kiln base body as making contact with the inner periphery of the kiln base body; and a vibratory device for applying vibrations to the kiln base body; or the like.

According to the zinc recovery method of the invention, it is preferred to supply carbon to the above-described burner device when the residue transferred into the burner device is combusted and heated as described above. If carbon is supplied to the burner device for combusting and heating the residue, some or all of the iron oxide as iron contained in the residue is reduced as combusted and heated along with carbon supplied to the burner device. In a case where iron oxide in the residue is recycled as reduced to iron, the amount of heat taken for reducing iron oxide is reduced. This results in the reduction of costs for recycling iron oxide in the residue by reducing iron oxide to iron.

### Advantageous Effects of Invention

According to the zinc recovery method of the invention, the dust containing zinc and iron is charged in the rotative kiln base body of the indirect-heating rotary kiln and heat treated as described above. Therefore, the dust can be treated with the temperature controlled to be in a range of 950° C. to 1000° C. where zinc is volatilized but no dioxin is produced. Hence, zinc can be readily recovered at low costs.

Further, the residue resulting from the above-described dust treatment in the kiln base body is transferred from the residue outlet disposed at the discharge part of the rotary kiln to the burner device, so that the residue is combusted and heated by the burner device. Therefore, the residue removed of zinc and rich in iron can be readily charged and molten in the electric furnace. Thus is achieved the low-cost, efficient utilization of iron contained in the residue. In addition, the costs required for the separately performed disposal of the residue can be reduced as well.

### BRIEF DESCRIPTION OF DRAWINGS

FIG. 1 is a schematic illustration diagram showing how an indirect-heating rotary kiln is used according to an embodiment of the invention where the dust containing zinc and iron is charged in a rotative cylindrical kiln base body and heat treated to recover zinc and the like from the dust;

FIG. 2 shows an adhesion inhibition means according to the embodiment hereof for inhibiting the adhesion of impurities onto the inside of the kiln base body, including FIG. 2A as a schematic sectional view showing a round member which includes a cylindrical member accommodating balls therein and rollably disposed in the kiln base body, and FIG. 2B as a schematic sectional view showing the round member which includes the cylindrical member accommodating the balls therein; and

FIG. 3 is a schematic sectional view showing an adhesion inhibition means according to the embodiment hereof for inhibiting the adhesion of impurities onto the inside of the kiln base body, the adhesion inhibition means which includes a scraper member disposed in the kiln base body and maintaining contact with an inner periphery of the kiln base body, and a vibratory device disposed on an outer side of the kiln base body for applying vibration to the kiln base body.

### BEST MODE FOR CARRYING OUT THE INVENTION

A zinc recovery method according to the embodiment of the invention will hereinbelow be described in detail according to the accompanying drawings. It is to be understood that the zinc recovery method according to the invention is not limited to the following embodiment but may include a variety of exemplary modifications so long as such modifications do not depart from the scope of the invention.

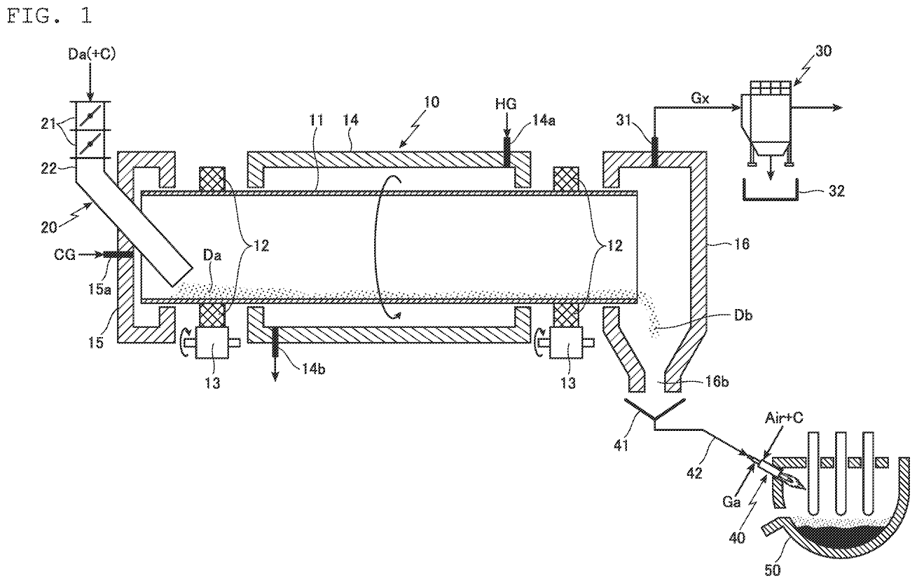

According to the embodiment of the invention, zinc and the like are recovered from a dust Da containing zinc and iron as follows. As shown in FIG. 1, a single-cylinder type rotary kiln 10 including one rotative cylindrical kiln base body 11 is used as an indirect-heating rotary kiln 10. The dust Da containing zinc and iron is charged in the kiln base body 11 from an inlet side of the rotary kiln 10. The dust is indirectly heated while rotating the kiln base body 11. Then the above-described dust Da is transferred to an outlet side of the rotary kiln 10.

The above-described rotary kiln 10 is provided with the following components in order to rotate the kiln base body 11. The kiln base body 11 includes: belt-shaped ring members 12 fitted on an outer periphery of the kiln base body at axially opposite places, and roller members 13 rotated in correspondence to the respective ring members 12. The roller members 13 are rotated so as to rotate the kiln base body 11 by means of the respective ring members 12.

In the above-described rotary kiln 10, the kiln base body 11 is indirectly heated as follows. An outer cylinder 14 made of a heat insulation material is mounted on the outer peripheral side of the kiln base body 11 in a manner to define a required distance from the outer periphery of the kiln base body 11. A heating gas (air heated to high temperatures) HG is introduced into space between the outer cylinder 14 and the kiln base body 11 through a lead-in pipe 14a extended through the outer cylinder 14 and disposed at a place close to the outlet side. The kiln base body 11 is heated with the heating gas HG. The heating gas HG thus having heated the kiln base body 11 is discharged through a lead-out pipe 14b extended through the outer cylinder 14 and disposed at a place close to the inlet side. The kiln base body 11 is heated by repeating the operations of introducing and discharging the heated gas in cycles.

According to the embodiment, a supply member 20 including a double damper 21 and a chute 22 charges the dust Da containing zinc and iron into the kiln base body 11 on the inlet side through a lead-in part 15 of the rotary kiln 10. Further, a carrier gas CG such as nitrogen is charged in the kiln base body 11 via a carrier gas lead-in pipe 15a disposed at the above-described lead-in part 15. The dust Da charged in the kiln base body 11 as described above is indirectly heated via the kiln base body 11 being rotated as described above, and heat treated in the above-described carrier gas CG. Thus, zinc contained in the dust Da is volatilized.

In a case where the dust Da containing zinc and iron is heat treated in the kiln base body 11 as described above, it is preferred to add carbon C to the dust Da before the dust is charged in the kiln base body 11 so that the dust is heat treated under a reducing condition. Thus, the dust Da can be heat treated with high efficiency.

A treated gas Gx containing volatilized zinc resulting from the heat treatment of the dust Da containing zinc and iron in the kiln base body 11 as described above is guided to a treatment device 30 such as a bag filter through an exhaust pipe 31 disposed at an upper part of a discharge part 16 of the rotary kiln 10. The above-described zinc is converted to zinc oxide and collected in a recovery bin 32.

A residue Db left after the above-described volatilization of zinc is transferred from the kiln base body 11 and collected by a residue collecting part 41 through a residue outlet 16b disposed at a bottom of the discharge part 16 of the rotary kiln 10. The residue Db collected by the residue collecting part 41 is supplied to a burner device 40 consisting of an injection burner via a residue carrier pipe 42.

A fuel gas Ga as well as Air and carbon C are fed to the burner device 40 thus supplied with the residue Db. The residue Db and carbon C are mixed together to be blown into an electric furnace 50 for combustion.

It is noted here that if the residue Db and caron C as mixed together are blown into the electric furnace 50 to be combusted, some or all of the iron oxide contained in the residue Db is reduced to iron, which is blown into the electric furnace 50. This results in the reduction of electric power used for melting the iron, facilitating an operation of recycling iron oxide into iron.

In this embodiment, the following problem may be encountered. In a case where the dust Da containing zinc and iron is charged in the kiln base body 11 which is heated while being rotated so that the dust Da containing zinc and iron is heated while being transferred in the kiln base body 11 in heat treatment as described above, the impurities and the like may adhere to the inner periphery of the kiln base body 11, interfering with the treatment of the dust Da.

According to the embodiment, therefore, it is preferred to mount an adhesion inhibition means on the inner periphery of the kiln base body 11 so as to inhibit the adhesion of the impurities.

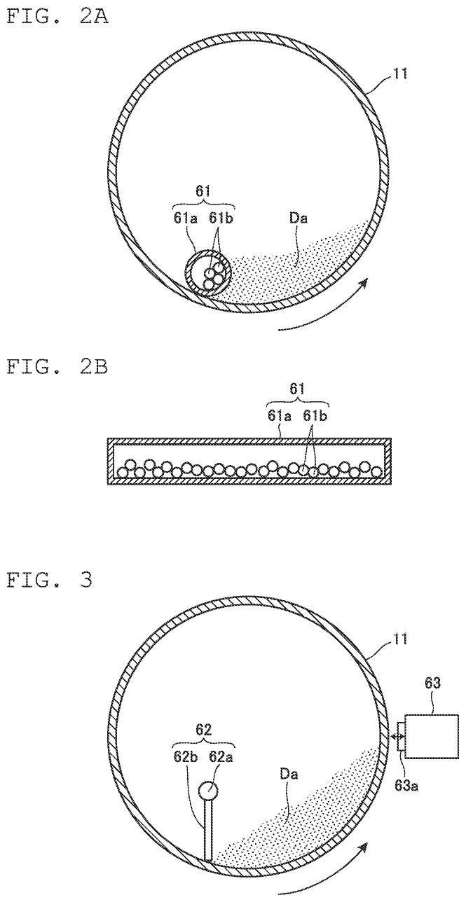

As shown in FIG. 2A and FIG. 2B, for example, such an adhesion inhibition means can be configured such that a round member 61 where a cylindrical member 61a closed at opposite ends thereof and accommodating a plurality of balls 61b therein is rollably disposed in the kiln base body 11 as aligned with an axial direction of the kiln base body 11. When the kiln base body 11 is rotated, with the plural balls 61b in the cylindrical member 61a moving in the cylindrical member 61a, the round member 61 in contact with the inner periphery of the kiln base body 11 is rotated in conjunction with the rotation of the kiln base body 11. When the balls 61b roll in the cylindrical member 61a or the piled balls 61b fall apart in space, as shown in FIG. 2A, the cylindrical member 61a is rolled due to the fluctuations of the gravity center of the cylindrical member 61a. Thus, the impurities and the like are inhibited by the round member 61 from adhering to the inner periphery of the kiln base body 11. Incidentally, the round member 61 rollably disposed in the kiln base body 11 is not limited to the above. A round bar and the like are also usable although the illustration thereof is not shown.

As shown in FIG. 3, for example, a scraper member 62 can also be used as the above-described adhesion inhibition means in the kiln base body 11. The scraper member includes: a support shaft 62a extended in the axial direction of the kiln base body 11; and a blade member 62b disposed in contact with the inner periphery of the kiln base body 11. The blade member 62b of the scraper member 62 is placed in contact with the inner periphery of the kiln base body 11 so as to inhibit the adhesion of the impurities to the inner periphery of the kiln base body 11. Alternatively, a vibratory device 63 is disposed on an outer side of the kiln base body 11. An oscillator 63a of the vibratory device 63 applies vibrations to the kiln base body 11 via an outer periphery thereof so as to inhibit the adhesion of the impurities and the like onto the inner periphery of the kiln base body 11.

According to the embodiment, a single-cylinder type rotary kiln 10 including a single cylindrical kiln base body 11 is used as the indirect-heating rotary kiln 10. However, the usable indirect-heating rotary kiln 10 is not limited to this. A multi-cylinder type rotary kiln 10 including a plurality of small-diameter kiln base bodies 11 circumferentially arranged at given space intervals is also usable although the illustration thereof is not shown. In a case where the multi-cylinder type rotary kiln 10 with the plural kiln base bodies 11 circumferentially arranged at given space intervals is used, the dust Da can be efficiently heat treated in the individual kiln base bodies 11 as described above. Therefore, the rotary kiln 10 can not only be downsized by reducing the length thereof but also can achieve further reduction of treatment cost.

### REFERENCE SIGNS LIST

10: rotary kiln
11: kiln base body
12: ring member
13: roller member
14: outer cylinder
14a: lead-in pipe
14b: lead-out pipe
15: lead-in part
15a: carrier gas lead-in pipe
16: discharge part
16b: residue outlet
20: supply member
21: double damper
22: chute
30: treatment device
31: exhaust pipe
32: recovery bin
40: burner device
41: residue collecting part
42: residue carrier pipe
50: electric furnace
61: round member
61a: cylindrical member
61b: balls
62: scraper member
62a: support shaft
62b: blade member
63: vibratory device
63a: oscillator
Air: Air
C: carbon
CG: carrier gas
Da: dust
Db: residue
Ga: fuel gas
Gx: treated gas
HG: heating gas

1. A zinc recovery method comprising the steps of:
charging dust containing zinc and iron in a rotative cylindrical kiln base body of an indirect-heating rotary kiln, and heat treating the dust in the kiln base body so as to volatilize zinc contained in the dust;
guiding the volatilized zinc to a treatment device through an exhaust pipe disposed at a discharge part of the rotary kiln and recovering zinc; and
transferring a residue resulting from the treatment in the kiln base body from a residue outlet disposed at the discharge part of the rotary kiln to a burner device in which the residue is combusted and heated.

2. The zinc recovery method according to claim 1, wherein as an adhesion inhibition means for inhibiting the adhesion of impurities to an inside of the kiln base body, a round member extending in an axial direction of the kiln base body is rollably disposed in the kiln base body.

3. The zinc recovery method according to claim 1, wherein as an adhesion inhibition means for inhibiting the adhesion of impurities to an inside of the kiln base body, a scraper member aligned with an axial direction of the kiln base body is disposed in contact with an inner peripheral surface of the kiln base body.

4. The zinc recovery method according to claim 1, wherein as the adhesion inhibition means for inhibiting the adhesion of the impurities to the inside of the kiln base body, a vibratory device for applying vibrations to the kiln base body is provided.

5. The zinc recovery method according to claim 1, wherein carbon is supplied to the burner device when the residue guided to the burner device is combusted and heated.
